(19) United States
(12) Patent Application Publication
(10) Pub. No.: US 2009/0165435 A1
(43) Pub. Date: Jul. 2, 2009

(54) Dual fuel can combustor with automatic liquid fuel purge

(76) Inventor: Michal Koranek, Burdova (CZ)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/003,829

(22) Filed: Jan. 2, 2008

(51) Int. Cl. F02C 3/24; F02C 7/12

(52) U.S. Cl. 60/39.463; 60/740

(57) ABSTRACT

A lean, low NOx gas-fired can combustor having liquid fuel operation capability includes a housing, a combustor liner disposed within the housing and defining a combustion zone for combusting fuel with air, and a head assembly for joining the longitudinal housing and liner ends and for supporting swirler vanes that admit about 45-55% of a total combustor air flow to the combustion zone. The head assembly includes multiple gaseous fuel injection ports upstream of the swirler vanes, and a single liquid fuel injector positioned along the liner axis for directing atomized liquid fuel into the combustion zone. The head assembly further includes a heat shield disposed between the injector and the combustion zone, and the head assembly is configured to provide a flow of air for cooling the heat shield during all operations of the can combustor. The can combustor may also include apparatus for automatically purging the liquid fuel injector with compressed air, such as cooled compressed air from a gas turbine engine compressor stage. The apparatus includes a shuttle valve controller including a shuttle member biased by a first pressure towards a first position interconnecting the liquid fuel input to the liquid fuel injector inlet, while blocking compressed purging air flow, and biased by a second pressure towards a second position interconnecting the compressed purging air input to the liquid fuel injector inlet, while blocking liquid fuel flow.

### BACKGROUND OF THE INVENTION

1. Field of the Invention

The invention relates to low emissions gas-fired can combustors with additional liquid fuel injection for both dual fuel and bi-fuel operations. The invention also relates to an automatic purging system for can combustors having liquid fuel injection.

2. Description of the Related Art

Most recent can-type combustors designed to meet low NOx regulations have concentrated on the application of gaseous fuels and mainly natural gas. The need for these designs to have at least stand-by capability on liquid fuel has led to significant problems of functionality, optimization, and operational control. The general problems in these designs stem from the use of multiple fuel injectors for the liquid fuel in an attempt to achieve the uniform distribution needed for the gaseous fuel system, which typically requires the use of multiple gas fuel ports distributed about the combustor head end. The number of liquid fuel injectors required for this approach is large, complex and can be costly.

Gas turbine multi-can combustion systems that use liquid fuel also need an effective distribution manifold and closely matched injectors to avoid temperature spread problems. The necessary supply system and pipe work can be further complicated by the additional need to purge liquid fuel injectors and related fuel passages of the residual fuel that can cause blockage due to “coking” under engine thermal soak conditions. The requirements for solenoid and stop valves to affect these requirements complicate the apparatus and add greatly to the cost.

Thus, simplification and cost reduction of these can combustor and purging system would be a design goal for the fuel system/combustion design in order to provide the engine with low first cost and satisfactory long term operational characteristics.

### SUMMARY OF THE DISCLOSURE

In a first aspect of the present invention, a gas-fired combustor having additional liquid fuel operation includes a can combustor housing having a longitudinal axis, a combustor liner disposed along the axis within the housing and defining a combustion zone for combusting fuel with air, and a head assembly for joining respective adjacent longitudinal housing and liner ends. The head assembly includes means for admitting gaseous fuel and air for combustion to the combustion zone, the admitting means including swirler vanes, wherein the swirler vanes are configured for admitting to the combustion zone, about 45-55% of a total combustor air flow at all times during operation of the can combustor. The head assembly also includes a single additional liquid fuel injector disposed substantially along the axis and having a nozzle for directing liquid fuel into the combustion zone during liquid fuel operation. The head assembly further includes a heat shield disposed between the injector and the combustion zone, and the head assembly is configured to provide a flow of air for cooling the heat shield at all times during operation of the can combustor.

In a second aspect of the present invention, apparatus for purging liquid fuel injector in a can combustor, wherein the can combustor is supplied with compressed air from a compressed air source and liquid fuel from a liquid fuel source for combustion in the can combustor, includes a liquid fuel controller having a liquid fuel input connectable to the fuel source, a compressed air input connectable to the compressed air source, and an output connected to the injector. The controller further includes a shuttle valve having a shut-off shuttle member biased by a first pressure towards a first position interconnecting the liquid fuel input to the controller output, and biased by a second pressure towards a second position interconnecting the compressed air input to the controller output. The first and second pressures are set to move the shuttle member to the first position when the can combustor is being operated with liquid fuel, and move the shuttle member to the second position when purging of the injector with compressed air from the compressed air source is required.

The accompanying drawings, which are incorporated in and constitute a part of this specification, illustrate embodiments and aspects of the invention and, together with the description, serve to explain the principles of the invention.

### BRIEF DESCRIPTION OF THE DRAWINGS

FIG. 1 is a schematic cross-section of a gas-fired can combustor with a single additional liquid fuel injector having automatic purge, in accordance with the present invention; and

FIG. 2 is a schematic of gas turbine engine employing the additional liquid fuel operation of FIG. 1.

### DETAILED DESCRIPTION

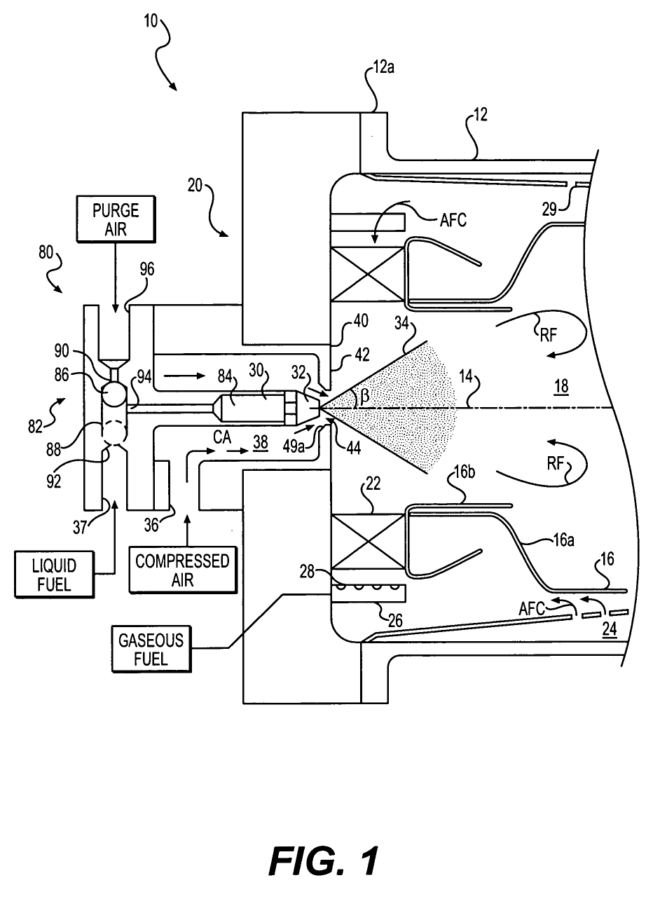

In accordance with the present invention, as broadly described herein, a dual fuel can combustor with automatic liquid fuel purge system includes a combustor housing having a longitudinal axis. As embodied herein, and with reference to FIG. 1, can combustor 10 includes housing 12, which is generally cylindrical with respect to longitudinal axis 14 although other general shapes can be used, as one of ordinary skill in the art would understand. Housing 12 includes a head end 12a.

Also in accordance with the present invention, as broadly described herein, the gas fired can combustor further includes combustor liner 16 disposed within, and radially spaced from, housing 12. Liner 16 is also substantially cylindrical about axis 14, but may include tapered, stepped, or “necked” portions of different diameters, such as liner end 16a including pre-chamber 16b, both shown longitudinally adjacent housing end 12a, in the FIG. 1 embodiment. Liner 16 can be fabricated with known high temperature metal alloys such as Hasteloy, and/or equivalent materials. Liner 16 defines an interior volume 18 that constitutes a combustion zone where fuel and combustion air are combusted to form combustion gases. These combustion gases exit can combustor 10 at a longitudinal end (not shown) opposite head end 12a e.g. for work-producing expansion such as in a turbine component of a gas turbine engine or gas generator. Liner 16 also defines a dilution volume or zone (not shown) where the temperature of the combustion gases is reduced by mixing with dilution air, prior to work-producing expansion.

Further in accordance with the present invention, as broadly described herein, the dual fuel can combustor includes a head assembly for joining respective adjacent longitudinal housing and liner ends. The head assembly also includes means for admitting gaseous fuel and air for combustion to the combustion zone. As embodied herein, and with continued reference to FIG. 1, head assembly 20 structurally joins, and radially spaces, housing 12 and liner 16 at longitudinal housing end 12a and longitudinal liner end 16a and pre-chamber 16b. Head assembly 20 also includes swirl vane assembly 22 which defines a plurality of channels for directing the flow of air for combustion from annular space 24 between housing 12 and liner 16 through liner pre-chamber 16b and into combustion zone 18, as depicted by arrows labeled “AFC.” Swirl vane assembly 22 is configured and oriented to impart a swirling motion about axis 14 to the combustion air entering combustion zone 18. For lean, low NOx operation, about 45-55% of the total combustor air flow (i.e. combustion air and dilution air) is admitted to the combustion zone as combustion air via the swirler, in order to attain a desired recirculated flow or pattern (depicted in FIG. 1 by arrows labeled “RF”) and stable combustion of the lean air/fuel mixture. The swirler vanes are inclined about 45° to a plane orthogonal to the axis.

The combustion air in annular space 24 flows generally counter to the longitudinal direction of the combustion gases exiting can combustor 10. This air for combustion can be used to cool the outer wall surface of liner 16, such as by convection cooling, film cooling, and/or impingement cooling, or combinations thereof. Impingement cooling, such as using perforated sleeve 29 as shown in the FIG. 1 embodiment, may be preferred for reasons set forth in co-pending commonly assigned application Ser. No. 11/984,055 filed Nov. 13, 2007.

Head assembly 20 may include a plurality of stub tubes 26 (only two being shown in FIG. 1) having orifices 28 for directing gaseous fuel into the entrance to the channels of swirl vane assembly 22, for mixing with the flowing combustion air. Introducing the gaseous fuel at the swirl channel entrances, rather than at the exits, provides better mixing with the combustion air. Stub tubes 26 may be provided with gaseous fuel (e.g. natural gas) from a source via appropriate conduits (not shown) in head assembly 20.

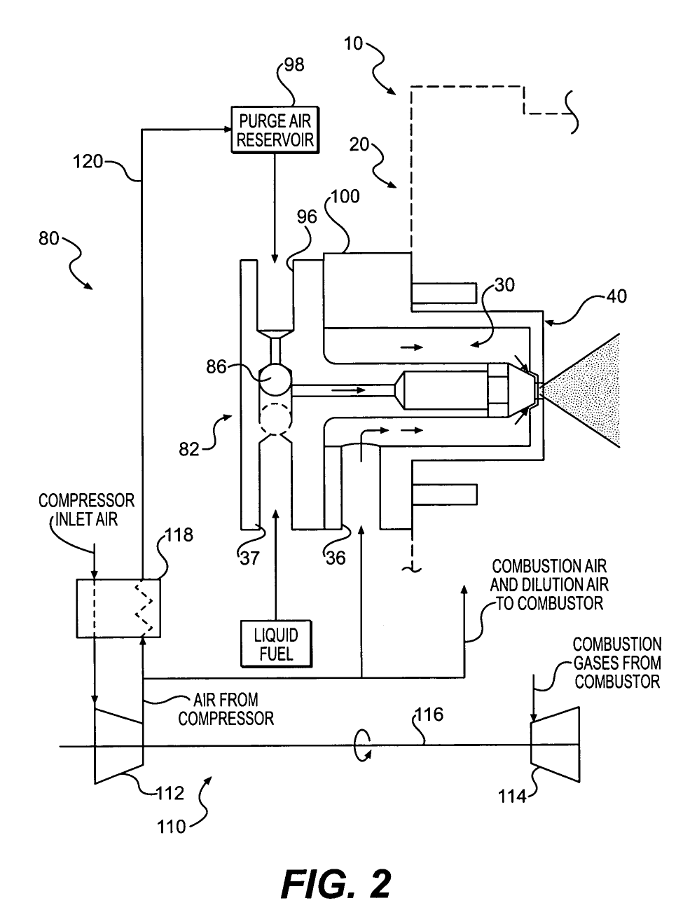

Still further in accordance with the present invention, as broadly described herein, the head assembly includes a single liquid fuel injector having a nozzle for directing liquid fuel into the combustion zone, the injector being disposed substantially along the housing axis. As embodied herein and as depicted in FIG. 1, head assembly 20 includes liquid fuel injector 30 having injector nozzle 32 positioned generally along housing axis 14. Liquid fuel injector 30 may be configured to generate a liquid fuel spray pattern 34 into the combustion air exiting swirl vane assembly 22, for admission to combustion zone 18, via liner pre-chamber 16b. Injector 30 may be an “air blast” type injector using compressed air to atomize the liquid fuel (e.g. diesel fuel) to provide a fine spray, which can be in a conical pattern, or “hollow” conical pattern, as depicted in FIG. 1. Head assembly 20 specifically includes compressed air inlet 36 for providing compressed air to injector 30 via plenum 38 in FIG. 1. Head assembly 20 also includes liquid fuel inlet 37 for supplying injector 30 from a liquid fuel source. The atomized liquid fuel in pattern 34 should have an angle β with respect to axis 14 that will minimize impingement of atomized fuel droplets on the inner wall of liner 16, particularly in the vicinity of pre-chamber 16b, to reduce carbon buildup. Angle β may depend upon the particular construction of the nozzle. In a gas turbine engine application, the compressed air source can be the engine compressor stage, as will be discussed subsequently in relation to FIG. 2.

Still further, in accordance with the present invention, as broadly described herein, the head assembly further includes a heat shield disposed between the injector and the combustion zone. Also, the head assembly is configured to provide a flow of air for cooling the heat shield at all times during operation of the can combustor. As embodied herein, and with continued reference to FIG. 1, head assembly 20 includes heat shield 40 having plate-like member 42 with central aperture 44. Plate 42 may be oriented essentially orthogonally to axis 14, and aperture 44 may be centered on axis 14. Aperture 44 may be sized to admit spray 34 from nozzle 32 into liner pre-chamber 16b and also to admit cooling air from plenum 38. The flow of cooling air (depicted by arrows marked “CA”) from plenum 38 serves to cool plate 42 and nozzle 32 before passing through aperture 44. Plate 42 can be longitudinally spaced from nozzle 32 and/or aperture 44 can have a chamfered inlet 44a to provide the desired flow of cooling air from plenum 38, as depicted in FIG. 1.

As would be understood by one skilled in the art, can combustor 10 could be configured to operate using both liquid fuel and gaseous fuel simultaneously or alternatively, such as by the use of an appropriate control system (not shown). A skilled artisan could readily construct such a control system given the present disclosure.

Still further in accordance with the present invention, as broadly described herein, the can combustor may include apparatus for automatically purging the liquid fuel injector using compressed air. Such a purging operation generally would occur following cessation of operation with liquid fuel (i.e. with the cutoff of liquid fuel flow) and continuation or resumption of operation with gaseous fuel. Because of the proximity of the liquid injector nozzle to the combustion zone, the combustion heat may otherwise act to carbonize any liquid fuel remaining in the injector and the injector nozzle.

As embodied herein, and with reference again to FIG. 1, purging apparatus, generally designated by the numeral 80, includes a source of compressed air for purging and a controller, such as controller 82 in head assembly 20, configured to automatically supply the compressed purging air to injector 30 through the injector liquid fuel inlet 84, when the liquid fuel is cut off. In the FIG. 1 embodiment, controller 82 is a shuttle valve having a shuttle member 86 disposed in chamber 88, which can be formed in a structural member of head assembly 20. Chamber 88 has a purge air inlet 90, a liquid fuel inlet 92, and a chamber outlet 94 connected to injector fuel inlet 84. Chamber fuel inlet 92 is fluidly connected to head assembly liquid fuel inlet 37, while chamber purge air inlet 90 is fluidly connected to head assembly purge air inlet 96.

In operation, the shuttle member 86 is moveable between a first position (depicted by solid lines in FIG. 1) which fluidly connects the liquid fuel source to injector fuel inlet 84 and blocks purge air flow, and a second position (shown dotted in FIG. 1) which fluidly connects the purging air source to injector fuel inlet 84 and blocks liquid fuel flow. Because shuttle member 86 may be configured to be responsive to the pressure difference between the pressure of the purge air source and the pressure of the liquid fuel source, movement from the first position to the second position can occur automatically upon liquid fuel cut off. During steady state gaseous fuel operation, the injector nozzle 32 is continuously purged from engine compressor 112 (FIG. 2) through head assembly purge air inlet 96.

FIG. 2 depicts a gas turbine gas generator application of can combustor 10 of FIG. 1, where only a part 100 of the head assembly 20 is shown in detail. As depicted, part 100, which may be configured to be a separate sub-assembly removable from the balance of head assembly 20, includes liquid fuel injector 30, heat shield 40, and controller/shuttle valve 82, together with respective associated head assembly inlets, namely for liquid fuel inlet 37, compressed air for heat shield cooling and atomization inlet 36, and purge air inlet 96. Specifically, FIG. 2 schematically depicts gas turbine gas generator 110 having an air compressor stage 112 and a turbine stage 114 interconnected by shaft 116 for inter-dependent rotation. Although depicted as axial flow components in FIG. 2, compressor 112 and/or turbine 114 could be radial flow components. In an application such as depicted in FIG. 2, compressor 112 may also serve as the compressed air source for liquid fuel nozzle 30 and for cooling heat shield 40, in addition to supplying air for combustion and dilution in can combustor 10, as depicted.

Moreover, compressor 112 also may supply compressed air for storage in a purge air reservoir 98, which may be a pressure vessel such as a cylinder, for use as the purge air source for purging apparatus 80. As shown in FIG. 2, purging apparatus 80 also may be configured to first cool the compressed air from compressor 112, such as by heat exchange apparatus 118 using inlet air flowing to compressor 112, before it flows via conduit 120 to charge the purge air vessel/cylinder 98. Compressed air exiting the compressor stage of a gas turbine engine or gas generator typically would have a temperature of several hundred degrees centigrade for reasonable compressor pressure ratios, and thus cooling before use in purging apparatus 80 may be necessary to prevent coking during purging.

It will be apparent to those skilled in the art that various modifications and variations can be made in the disclosed dual fuel can combustor and the automatic purging apparatus without departing from the teachings contained herein. Although other embodiments will be apparent to those skilled in the art from consideration of this specification and practice of the disclosed apparatus, it is intended that the specification and examples be considered as exemplary only, with the true scoping indicated by the following claims and their equivalents.

What is claimed is:

1. A gas-fired can combustor having liquid fuel operation capability comprising:
a can combustor housing having a longitudinal axis;
a combustor liner disposed along the axis within the housing and defining a combustion zone for combusting fuel with air;
a head assembly for joining respective adjacent longitudinal housing and liner ends, the head assembly including means for admitting gaseous fuel and air for combustion to the combustion zone, the admitting means including swirler vanes for imparting swirl to the combustion air,
wherein the swirler vanes are configured for admitting to the combustion zone about 45-55% of a total combustor air flow at all times during the operation of the can combustor;
wherein the head assembly includes a single liquid fuel injector having a nozzle for directing liquid fuel into the combustion zone, the liquid fuel injector being disposed substantially along the axis, and
wherein the head assembly further includes a heat shield disposed between the injector and the combustion zone, the head assembly being configured to provide a flow of air for cooling the heat shield at all times during operation of the can combustor.

2. The can combustor as in claim 1, wherein the liquid fuel injector is configured to use compressed air to atomize the liquid fuel from the nozzle, and wherein the head assembly is configured to provide compressed air from a compressed air source to the liquid fuel injector.

3. The can combustor as in claim 2, wherein the head assembly also is configured to provide compressed air from the compressed air source for cooling the heat shield.

4. The can combustor as in claim 1, wherein the head assembly also is configured to provide the cooling air flow for cooling the heat shield during operation of the can combustor with gaseous fuel.

5. The can combustor as in claim 3, wherein the cooling air flow used for cooling the heat shield is about 1% or less of the total combustor air flow.

6. The can combustor as in claim 2, wherein the heat shield and nozzle are configured to provide a conical spray pattern for the atomized liquid fuel entering the combustion zone, the spray pattern having an angle, and wherein the conical spray angle is selected to avoid impingement of liquid fuel on adjacent wall surfaces of the liner.

7. The can combustor as in claim 6, wherein the conical spray pattern is a hollow conical spray pattern.

8. The can combustor as in claim 1, wherein the liquid fuel injector and the heat shield are configured as a removable subassembly part of the head assembly.

9. The can combustor as in claim 1, further including a liquid fuel connection between a liquid fuel source and the injector, wherein the liquid fuel connection also includes means for automatically purging the injector using compressed air following cessation of operation with liquid fuel.

10. The can combustor as in claim 9, wherein the purging means includes a pressure-activated controller having pressure inputs from a compressed purging air source and the liquid fuel source.

11. The can combustor as in claim 10, wherein the compressed purging air source includes a pressurized vessel of compressed purging air.

12. The can combustor as in claim 1 1, wherein the can combustor is part of a gas turbine engine having an air compressor, and wherein the purging means includes means for providing cooled compressed air from the compressor to the vessel.

13. The can combustor as in claim 1, configured to burn gaseous fuel and liquid fuel simultaneous or alternatively.

14. The can combustor as in claim 2, wherein the injector heat shield includes a plate positioned substantially orthogonal to, and axially spaced from, the injector nozzle; wherein the injector is configured such that a portion of the compressed air supplied to the injector is channeled to cool the plate by impingement cooling; and wherein the plate has an aperture for admitting to the combustion zone the liquid fuel ejected from the injector nozzle and the cooling air.

15. The can combustor as in claim 2, wherein the head assembly includes a compressed air plenum in flow communication with the compressed air source, and wherein the atomization air and the cooling air are provided by the plenum.

16. Apparatus for purging a liquid fuel injector in a can combustor, the can combustor being supplied liquid fuel from a liquid fuel source for combustion in the can combustor, the apparatus comprising:
a source of compressed air for purging;
a liquid fuel controller having a liquid fuel inlet connectable to the fuel source, a compressed air inlet connectable to the compressed purging air source, and an outlet connectable to the injector,
wherein the controller further comprises a shuttle valve including a shuttle member biased by a first pressure towards a first position interconnecting the liquid fuel input to the controller outlet, and biased by a second pressure towards a second position interconnecting the compressed air input to the controller outlet, and
wherein the first and second pressures are set to automatically move the shuttle member to the first position when the can combustor is being operated with liquid fuel, and automatically move the shuttle member to the second position when purging of the injector with compressed air from the compressed air source is required.

17. The purging apparatus as in claim 16, wherein the can combustor has a head assembly in which the injector is mounted, and wherein the shuttle valve is configured as part of the head assembly.

18. The purge apparatus as in claim 16, wherein the can combustor is part of a gas turbine engine, the engine having an air compressor, and wherein the apparatus includes a conduit from the air compressor to the shuttle valve compressed purging air inlet.

19. The purge apparatus as in claim 18, further including a pressure vessel operatively connected to the conduit for being pressurized with compressed air from the air compressor, and for supplying compressed air to the shuttle valve compressed purging air inlet during engine shut down.

20. The purge apparatus as in claim 18, further including means for cooling the compressed air before it is provided to the shuttle valve compressed purging air inlet.
